(19) United States
(12) Patent Application Publication
(10) Pub. No.: US 2025/0053431 A1
(43) Pub. Date: Feb. 13, 2025

(54) SYSTEM AND METHOD FOR IMPLEMENTING AUTOMATED PROCESS AND APPLICATION TRANSFORMATION

(71) Applicant: KPMG LLP, New York, NY (US)

(72) Inventors: Aaron Purcell, Frisco, TX (US); Amit Dua, Kendall Park, NJ (US); Hoi-Hung Tsang, Syosset, NY (US)

(21) Appl. No.: 18/800,789

(22) Filed: Aug. 12, 2024

Related U.S. Application Data
(60) Provisional application No. 63/531,871, filed on Aug. 10, 2023.

(51) Int. Cl. G06F 9/451; G06F 8/38

(52) U.S. Cl. CPC G06F 9/453; G06F 8/38

(57) ABSTRACT

The invention relates to computer-implemented systems and methods for implementing an automated process and application transformation solution. An embodiment of the present invention is directed to accelerating the digital transformation of legacy applications, e.g., moving older applications to new targeted solutions. An embodiment of the present invention is directed to creating a sequential approach to automating these stages using a combination of technologies and Artificial Intelligence (AI) capabilities. These AI capabilities further augment existing resources and enhance experiences.

### CROSS-REFERENCE TO RELATED APPLICATIONS

The application claims priority to U.S. Provisional Application 63/531,871 (Attorney Docket No. 055089.0000110), filed Aug. 10, 2023, the contents of which are incorporated by reference herein in their entirety.

### FIELD OF THE INVENTION

The present invention relates to systems and methods for providing automated process and application transformation.

### BACKGROUND

As technology continues to advance and improve, companies need to stay current. Traditional approaches require extensive manual involvement at a slow pace that is costly with a high level of risk. Even with low code or no code platforms that reduce cycle and errors, there is a tremendous amount of manual tasks which results in inefficiencies at all levels.

It would be desirable, therefore, to have a system and method that could overcome the foregoing disadvantages.

### SUMMARY

According to one embodiment, the invention relates to a computer-implemented system that implements an automated process and application transformation solution. The system comprises: a tracking interface that performs data acquisition by dynamically capturing user interactions with at least one application via a communication network; a storage component that stores and manages the dynamically captured user interactions; an optimization processor that initiates a process transformation that correlates the dynamically captured user interactions and system activity data to generate an application model wherein the application model is optimized through a business process map and at least one recommendation for enhancement; responsive to the business process map, a code generation processor that generates a user guide interface, monitors data flows and automatically generates application computer code for transformation implementation to a target application; and a workflow automation processor that deploys the application computer code in a target environment for transformation adoption and continuously gathers data and provides feedback for updated optimization for continuous improvement.

According to another embodiment, the invention relates to a computer-implemented method that implements an automated process and application transformation solution. The method comprises the steps of: performing, via a tracking interface, data acquisition by dynamically capturing user interactions with at least one application via a communication network; storing and managing, via a storage component, the dynamically captured user interactions; initiating, via an optimization processor, a process transformation that correlates the dynamically captured user interactions and system activity data to generate an application model wherein the application model is optimized through a business process map and at least one recommendation for enhancement; responsive to the business process map, generating, via a code generation processor, a user guide interface, monitors data flows and automatically generates application computer code for transformation implementation to a target application; and deploying, via a workflow automation processor, the application computer code in a target environment for transformation adoption and continuously gathers data and provides feedback for updated optimization for continuous improvement.

An embodiment of the present invention is directed to providing an automated process and application transformation solution. An embodiment of the present invention recognizes that many entities are in the process of converting software from old technology to new technology. To successfully accomplish the conversion in an efficient and optimal manner, there are a number of challenges to address.

A first challenge involves needing to understand current processes and the features and functions that are supported. Oftentimes, relevant documentation is no longer available, and time and resources are required to interview and ascertain the relevant information for each application. Entities may have hundreds and hundreds of applications that need conversion.

A second challenge involves optimization of the new technology and updated solutions. Currently, the process is manual and involves best guesses from experienced users.

A third challenge looks at how to efficiently design and code the new solutions. This is generally a long and tedious process that may take months to find the coders with the relevant expertise and experience as well as capacity to handle the workload.

A fourth challenge involves informing and training users on properly and effectively using the new technology. This may involve identifying the differences in workflow and overall use.

Each of these challenges requires significant resources and extensive time commitments with varying and sometimes inconsistent results. An embodiment of the present invention is directed to addressing each challenge through an innovative sequence of technology capabilities that automate and integrate artificial intelligence (AI) at critical steps. The automated transformation process streamlines efforts with a high level of accuracy, low risk, reduced cost and labor dependencies.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary data flow diagram, according to an embodiment of the present invention.

FIG. 2 is an exemplary illustration of task level activities, according to an embodiment of the present invention.

FIG. 3 is an exemplary task mining process, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to accelerating the digital transformation of legacy applications, e.g., moving older applications to newer target solutions/environments. Automation may involve multiple stages including requirements gathering, process improvement tracking, new solution design and new technology implementation. An embodiment of the present invention is directed to creating a sequential approach to automating these stages using a unique combination of technologies and Artificial Intelligence (AI) capabilities. These AI capabilities further augment existing resources and significantly enhance user experiences.

An embodiment of the present invention provides an intelligent approach to automated process and application transformation resulting in low labor involvement and fast and repeatable tasks. Through advancements in AI and process mining platforms, manual tasks are significantly reduced with improved accuracy and reduced risk.

An embodiment of the present invention is directed to a unique combination of processing tools, such as (1) a Browser Interactive Guide and Tracking Platform, (2) a Process Mining and Optimization Platform, (3) a Code Generation Platform and (4) Workflow Automation Platform. The unique combination of tools and processing components provide an innovative multi-stage approach to process and application transaction. The multi-stage approach may include: data acquisition; process transformation; transformation implementation; transformation adoption and continuous improvement.

The Browser Interactive Guide and Tracking Platform or Tracking Platform may perform user interaction capture and further review the captured data. The Process Mining and Optimization Platform may perform data mining and develop workflow optimization. The Code Generation Platform may perform data flow refinement and code generation. The Workflow Automation Platform may perform workflow execution and automation. Variations and/or other tools may be implemented to support a range of applications, businesses, use cases, environments, etc.

An embodiment of the present invention captures user interaction through a Tracking Platform. For example, the Tracking Platform may capture keystrokes and other user actions on a browser or other user interface executing on a computer processor, mobile device, terminal, etc. User actions may include entering time, filing a request, communicating data, performing tasks, accessing multiple tools, etc. The captured user interaction may then be received by a Process Mining and Optimization Platform, which also receives system log activity to create a process view. This provides a comprehensive understanding of current processes and how various features and functions are supported. For example, different users may interact with the same application in numerous different ways creating multiple workflows and optimization considerations.

The Process Mining and Optimization Platform may integrate AI capabilities in analyzing tasks and processes as well as providing recommendations for optimization and improvement. For example, an embodiment of the present invention may identify several variances for a certain task and then recommend an optimal workflow to achieve efficiencies in time, resources and/or other metric. In this example, multiple scenarios may be analyzed and variations in efficiency and workflow may be provided. Further, rate card information may be considered where a persona may be assigned to tasks at an hourly rate or other measure. A particular workflow may cost the entity $X while an optimal workflow will cost the entity $Y. Other factors representing efficiencies and optimization may be considered and provided for analysis and review.

Process mining may involve analyzing data from an organization's IT systems to create a visual representation of the actual process flows. This technique allows organizations to identify bottlenecks, inefficiencies, and/or other issues in their processes, and to optimize them to improve performance. Process mining may use techniques such as process discovery, conformance checking, and performance analysis to analyze the process flows.

Task mining focuses on analyzing the actions of individual workers within a process. This technique involves capturing data from the user's computer, such as mouse clicks, keystrokes, and application usage, to understand how they perform their tasks. Task mining may provide insights into how workers interact with different systems, where they encounter roadblocks, and what they do to overcome them.

While both task mining and process mining may be used to optimize business processes, they serve different purposes. Process mining may be focused on understanding the overall process flow and identifying opportunities for improvement, while task mining may be focused on understanding how workers interact with the process and identifying ways to improve their productivity and efficiency. Together, these techniques provide a comprehensive view of the process and help organizations to optimize it at every level.

The Optimization Platform may provide an optimal business process map which may then be inputted to a Code Generation Platform to automatically generate code for execution through a Workflow Automation Platform. An embodiment of the present invention is directed to creating workflow code from a business process map that has been optimized and ready for execution through a Workflow Automation Platform.

An embodiment of the present invention may be applied to various applications including an Advisory Practice and other services that collect data and process transformation through optimization.

An embodiment of the present invention recognizes different users, roles and/or personas. For example, an embodiment of the present invention may identify a set of attributes for each user and then associate the set of attributes to a particular role, responsibility and/or location. This enables the system to recognize that different users, depending on their responsibilities, may interact with an application in a different manner. For example, an IT director in New Jersey may interact differently with an application than a Tax Partner in California.

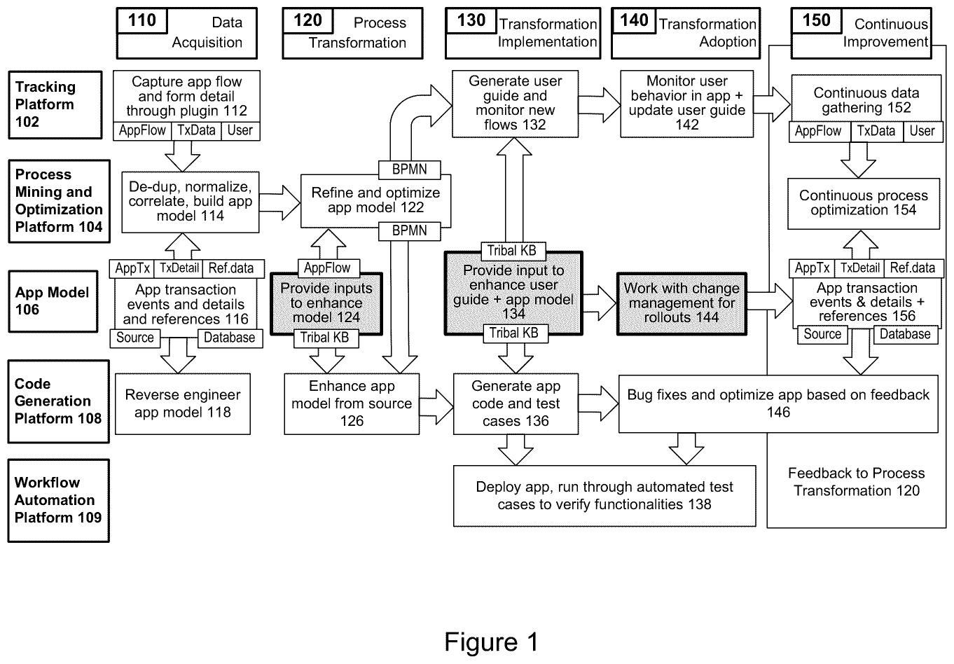

FIG. 1 is an exemplary data flow diagram, according to an embodiment of the present invention. FIG. 1 illustrates multiple stages of an automated process and application transformation. The multi-stage approach may include: Data Acquisition 110, Process Transformation 120, Transformation Implementation 130, Transformation Adoption 140 and Continuous Improvement 150. While the process of FIG. 1 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

An embodiment of the present invention may support various components in different combinations and configurations. According to an exemplary embodiment, components may include: Tracking Platform 102, Process Mining and Optimization Platform 104, Application Model 106, Code Generation Platform 108 and Workflow Automation Platform 109. Other variations may be supported.

Data Acquisition 110 may involve collecting application data and user interaction information via a browser and/or other sources to accurately ascertain how applications are being used. This information may be used to build insights through artificial intelligence. Step 112 may capture app flow and form details through a plug-in, at step 112. For example, data acquisition may involve mining out task level activities through browser extensions. According to an embodiment of the present invention, data may be collected dynamically using AI to create data insights. This reduces human error and dramatically reduces the overall timeline.

Tracking Platform 102 may capture user interaction and usage information from a browser extension. Process Mining and Optimization Platform 104 may then perform a de-duplication and normalization process. More specifically, step 114 de-dups, normalizes, correlates and builds an application model. Step 116 captures application transaction events and details including references. Step 118 performs reverse engineering of the application model from sources, databases, etc. Here, the captured information may be correlated with system activity through a common identifier or other linking information.

In addition, Data Acquisition 110 may support capturing user interaction from various tools, including browsers, mobile tools, applications, out of band tools, etc. For example, while a user interacts with a particular application executing on a browser, the user may send a message seeking approval through a communication tool executing on a separate platform. In addition, the system may also capture user actions from multiple devices. For example, while a user interacts through a desktop version, the user may also perform a related function through a mobile or other device. An embodiment of the present invention may capture user actions through multiple applications and tools as well as across a suite of devices and platforms. According to another scenario, the system may also consider how a team interacts with an application and then aggregate interactions from multiple users.

Process Transformation 120 may support automatic generation of models and the ability to add improvements and refinements. In addition, optimization may be provided and previewed through AI/ML and further refined upon through intelligent feedback and/or other inputs. Process Transformation 120 may be business objective focused and based on data driven decisions. Other intelligent features including scenario planning may be provided where optimization based on performance and resource metrics may be identified.

Step 122 may refine and optimize the app model. At step 124, inputs may be provided to enhance the model. Inputs may be automatically generated as well as through user interaction. Step 126 enhances the app model from source data.

Process Transformation 120 may involve feeding task mining information into Process Mining and Optimization Platform 104 to create 360 degree views on BPM (Business Process Management). BPM may represent a discipline involving any combination of modeling, automation, execution, control, measurement and optimization of business activity flows, in support of enterprise goals, spanning systems, employees, customers and partners within and beyond the enterprise boundaries. Outputs may be reviewed with stakeholders using AI to implement process improvement recommendations. According to an embodiment of the present invention, business process mapping may be performed dynamically with recommendations on areas of improvement and optimization. Data insights provide objective information around optimized process recommendations.

Process Mining and Optimization Platform 104 may refine and optimize an application model, as shown by step 122. Using AI technology, an embodiment of the present invention provides recommendations for optimization. Other features may include scenario planning where different scenarios may be applied to show varying levels of efficiency based on metrics, such as duration, resources, cost, etc.

Business Process Modeling and Notation (BPMN) represents a model language that is based on flowcharts and graphical notations. This provides the ability to define business processes as sequence or flow diagrams. Other tools and models may be used.

Transformation Implementation 130 may provide code generation through models. This provides fast delivery while ensuring quality and consistency with a focus on adhering to best practices. Step 132 may generate a user guide and monitor new flows. The user guide may serve as a reference to an end user. At step 134, inputs may be provided to enhance the user guide and application model. As shown in FIG. 1, Tribal KB represents a Tribal Knowledge base that may be captured from interactions with current teams supporting the application. In addition, inputs may be automatically generated through user interaction. Step 136 generates application code and test cases. Step 138 deploys the application and runs through automated test cases to verify functionalities.

As users interact with a converted and/or optimized application, Tracking Platform 102 may engage the user with an interactive help function that provides immediate, instant and personalized assistance, that may be driven by AI and serves as a virtual guide to the new application.

Based on the captured activity, an embodiment of the present invention may generate and provide recommendations for optimization and efficiencies. For example, recommendations may relate to updates to a screen design based on user activity, such as moving certain buttons/icons to a center of the screen to optimize, streamline and simplify user experience.

An embodiment of the present invention may then provide recommendations for optimization. Based on the recommendations and/or business process map, a Code Generation Platform 108 may then automatically create the supporting code. Code Generation Platform 108 may represent a platform that uses generative AI (Gen AI) to automate and modernize enterprise applications. For example, Code Generation Platform 108 may ingest legacy application code and create business process maps to generate code.

With Transformation Implementation 130, business process maps may feed into generative AI to create code for new processes. For example, business process maps may be dynamically turned into code. This dramatically reduces time to delivery and further improves code quality and consistency.

An embodiment of the present invention is directed to automatically generating and implemented code, which may occur directly or with some human review and/or interaction. For example, the code may be fully automated and executed on. According to another example, the generated code may require human review/approval. The code may be provided in a basic format as a starting point where a human coder would then complete and execute. Other variations and level of human interaction may be supported.

An embodiment of the present invention is directed to digitizing and transforming each element of the conversion process while working with business owners to optimize how business processes are run. The innovative system works with technology experts to optimize delivery of tools/applications and further assist end users on how to effectively and efficiently use the tools/applications.

Transformation Adoption 140 may involve automatically updating via the application model and embedding a guide in the application thereby providing a personalized and streamlined transition. Step 142 may monitor user behavior in the application and update the user guide. At step 144, user input may work with change management for rollouts. Step 146 performs bug fixes and optimizes the application based on feedback.

Transformation Adoption 140 enables the creation of digital adoption aids in a browser interactive guide and tracking platform, as shown by Tracking Platform 102, to introduce and manage change activities. According to an embodiment of the present invention, business process maps may be used to create adoption insights. Adoption platforms may be used to track adherence. This dramatically decreases OCM (Organizational Change Management) time. OCM may represent a discipline of managing enterprise changes (e.g., changes to what products and technologies are used, process changes, or changes in team structures, etc.) to minimize disruption and help people embrace and support the change. Immediate feedback through adoption platform allows for quick and continuous adjustments.

User interaction may be supported at various stages including step 124, 134, and 144.

Continuous Improvement 150 may support automated deployment as well as continuous tracking and optimization. Step 152 provides continuous data gathering. Step 154 performs continuous process optimization. Step 156 identifies app transaction events and details with references. The process may feedback to step 120.

Continuous Improvement 150 may involve monitoring for process optimization opportunities and initiating the cycle again automatically. According to an embodiment of the present invention, a digital flow provides automated continuous improvement (CI). This dramatically decreases time to implement improvements and further avoids long disconnects around identification of improvement opportunities.

An embodiment of the present invention may determine compatibility with workflow tools. This may involve predicting an optimal workflow tool for a particular business process flow map.

An embodiment of the present invention may dynamically update code as a result of a process deviation, lack of process optimization and/or other factors.

An embodiment of the present invention is directed to providing a comprehensive view (through a merging of a Tracking Platform and Process Mining and Optimization Platform) and integration of AI capability for optimization. An embodiment of the present invention is directed to generating code based on a recommended business process flow with optimization.

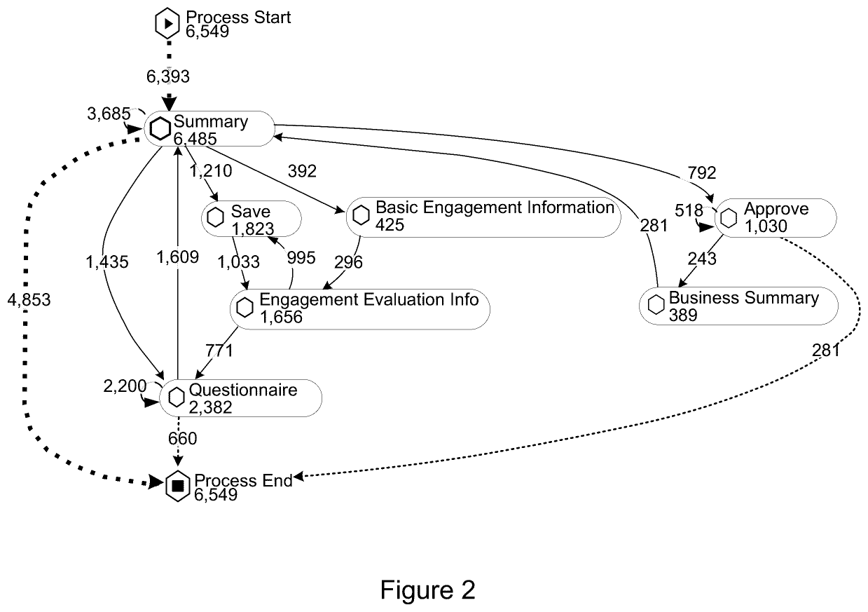

FIG. 2 is an exemplary illustration of task level activities, according to an embodiment of the present invention. A browser interactive guide and tracking platform may provide task level activities as shown in FIG. 2. For example, the browser interactive guide and tracking platform may collect user session information inside of a browser or other user interface.

This may provide task insights. Additionally, the platform may track behaviors indicating out of band activities. The platform may further provide session playback to review task activities.

Deviations in lines illustrate different interactions with the application. In this example, the counts represent the number of times the interaction was executed. Other metrics such as duration and other interaction data may be captured as well. This data may provide insights as to how many users follow a certain workflow or interaction and further suggest an improved workflow for consideration.

According to an exemplary implementation, a browser interactive guide and tracking platform may be combined with a process mining and optimization platform to provide a complete view of activities. Additional insights around activities may be provided including out of band indicators. Other combinations and implementations may be supported.

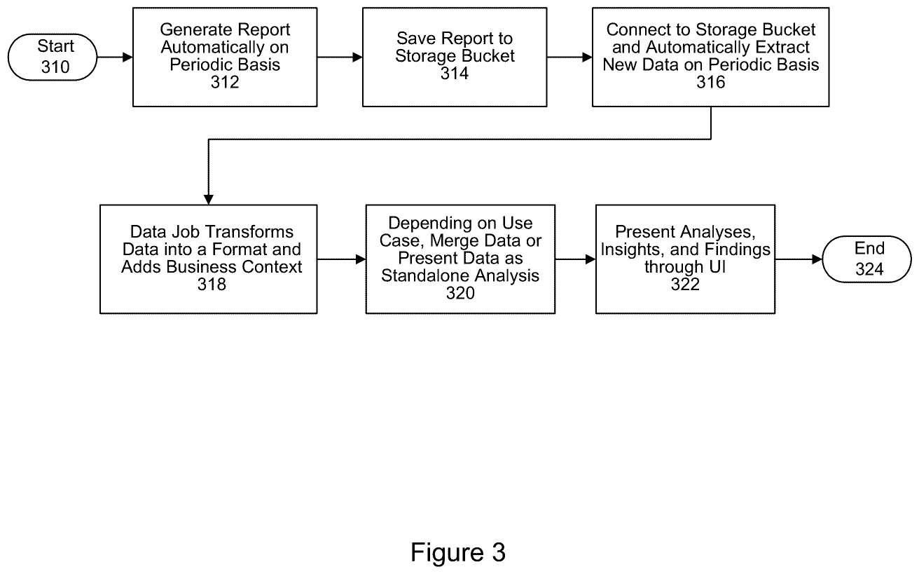

FIG. 3 is an exemplary task mining process, according to an embodiment of the present invention. The task mining process starts at 310. At step 312, a report generates automatically on a daily or other periodic basis. At step 314, the report may be saved to a storage bucket. At step 316, a process mining and optimization platform may connect to a storage bucket and automatically extract new data on a daily or other periodic basis. At step 318, a data job may transform data into a format (e.g., process mining format) and business context may be added. At step 320, depending on a use case, the process mining and optimization platform may merge data or present data as standalone analysis. At step 322, a user interface may present analysis, insights and findings. The process ends at 324.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the System software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, an apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

What is claimed is:

1. A computer-implemented system for implementing an automated process and application transformation solution, the system comprising:
a tracking interface that performs data acquisition by dynamically capturing user interactions with at least one application via a communication network;
a storage component that stores and manages the dynamically captured user interactions;
an optimization processor that initiates a process transformation that correlates the dynamically captured user interactions and system activity data to generate an application model wherein the application model is optimized through a business process map and at least one recommendation for enhancement;
responsive to the business process map, a code generation processor that generates a user guide interface, monitors data flows and automatically generates application computer code for transformation implementation to a target application; and
a workflow automation processor that deploys the application computer code in a target environment for transformation adoption and continuously gathers data and provides feedback for updated optimization for continuous improvement.

2. The system of claim 1, wherein artificial intelligence (AI) is applied to the captured user interactions to create one or more data insights.

3. The system of claim 1, wherein the tracking interface comprises a browser interactive guide and tracking platform.

4. The system of claim 3, wherein the browser interactive guide and tracking platform dynamically captures user interaction and usage information.

5. The system of claim 4, wherein the user interaction comprises a sequence of user actions through one or more applications from a single user.

6. The system of claim 4, wherein the user interaction comprises a sequence of user actions through one or more applications from multiple users.

7. The system of claim 1, wherein the system activity data is analyzed to create a visual representation of one or more process flows.

8. The system of claim 7, wherein the one or more process flows identify one or more of: bottlenecks, inefficiencies and process issues that are used to improve optimization.

9. The system of claim 1, wherein the workflow automation processor generates workflow analysis, insights and findings that are transmitted to an interactive user interface.

10. The system of claim 1, wherein the user guide interface provides immediate and personalized assistance as a virtual guide to the target application.

11. A computer-implemented method for implementing an automated process and application transformation solution, the method comprising the steps of:
performing, via a tracking interface, data acquisition by dynamically capturing user interactions with at least one application via a communication network;
storing and managing, via a storage component, the dynamically captured user interactions;
initiating, via an optimization processor, a process transformation that correlates the dynamically captured user interactions and system activity data to generate an application model wherein the application model is optimized through a business process map and at least one recommendation for enhancement;
responsive to the business process map, generating, via a code generation processor, a user guide interface, monitors data flows and automatically generates application computer code for transformation implementation to a target application; and
deploying, via a workflow automation processor, the application computer code in a target environment for transformation adoption and continuously gathers data and provides feedback for updated optimization for continuous improvement.

12. The method of claim 11, wherein artificial intelligence (AI) is applied to the captured user interactions to create one or more data insights.

13. The method of claim 11, wherein the tracking interface comprises a browser interactive guide and tracking platform.

14. The method of claim 13, wherein the browser interactive guide and tracking platform dynamically captures user interaction and usage information.

15. The method of claim 14, wherein the user interaction comprises a sequence of user actions through one or more applications from a single user.

16. The method of claim 14, wherein the user interaction comprises a sequence of user actions through one or more applications from multiple users.

17. The method of claim 11, wherein the system activity data is analyzed to create a visual representation of one or more process flows.

18. The method of claim 17, wherein the one or more process flows identify one or more of: bottlenecks, inefficiencies and process issues that are used to improve optimization.

19. The method of claim 11, further comprising the steps of: generating workflow analysis, insights and findings; and transmitting the workflow analysis, insights and findings to an interactive user interface.

20. The method of claim 11, wherein the user guide interface provides immediate and personalized assistance as a virtual guide to the target application.
